(19) United States
(12) Patent Application Publication
(10) Pub. No.: US 2019/0018379 A1
(43) Pub. Date: Jan. 17, 2019

(54) GENERATOR WITH WIRELESS LOAD MONITORING AND WIRELESS POWER MANAGEMENT

(71) Applicant: Briggs & Stratton Corporation, Wauwatosa, WI (US)

(72) Inventors: Michael Miller, Lake Mills, WI (US); Brian Northway, Hartford, WI (US)

(73) Assignee: Briggs & Stratton Corporation, Wauwatosa, WI (US)

(21) Appl. No.: 16/031,344

(22) Filed: Jul. 10, 2018

Related U.S. Application Data
(60) Provisional application No. 62/531,025, filed on Jul. 11, 2017.
(60) Provisional application No. 62/671,059, filed on May 14, 2018.

(51) Int. Cl. G05B 19/042; H04L 12/28; H04L 29/06

(52) U.S. Cl. CPC G05B 19/042; H04L 12/2834; G05B 2219/2639; H04L 2012/2841; H04L 69/18

(57) ABSTRACT

A system and method for controlling and monitoring a plurality of wireless devices at a secondary power source, such as a standby generator. The standby generator received information from one or more wireless devices in a home and either modifies the operation of the generator or modifies the operation of the wireless devices. The system can include one or more power management modules that monitor the operation of large power consuming loads, such as air conditioners. The power management modules communicate to the standby generator, which can control the operation of the load through the power management module.

### CROSS REFERENCE TO RELATED APPLICATIONS

The present application is a based on and claims priority to U.S. Provisional Patent Application Ser. No. 62/671,059, filed on May 14, 2018 and U.S. Provisional Patent Application Ser. No. 62/531,025, filed on Jul. 11, 2017, the disclosures of which are each incorporated herein by reference.

### BACKGROUND

The present disclosure generally relates to a system and method for monitoring loads serviced by a secondary power source. More specifically, the present disclosure relates to a system and method that monitors the operation of wireless devices and the energy consumption of individual energy consuming loads when electrical power is provided from a secondary power source, such as a standby generator.

Presently, the systems and methods exist for monitoring the energy consumption of individual devices within a home or business environment. Typically, these devices include some type of monitoring and communication unit that relays energy consumption information to a utility such that the utility can monitor energy consumption at a home or business in real time. Although such systems exist to monitor energy consumption, when energy is interrupted to a home or business, the energy monitoring functions generally are disabled or not available. However, during this interruption in power supply, secondary power supplies such as standby generators can provide electrical power to many of these energy consuming devices within the home. In accordance with the present disclosure, the standby generator at the home or business can monitor energy consumption of a series of energy consuming devices utilizing a wireless communication technique.

In addition to monitoring power consuming loads in a home, a large number of wirelessly enabled devices are being used in a home to provide both remote monitoring and control. As an example, wireless thermostats allow a home owner to change the temperature set point in a home from a remote location. Wireless smoke detectors, CO monitors, light, appliances and other devices in a home provide a wide variety of possible control and monitoring options. Thus, a need and desire exists to monitor and control these devices when a secondary power source is operating upon utility power disruption.

### BRIEF DESCRIPTION OF THE DRAWINGS

The drawings illustrate the best mode presently contemplated of carrying out the disclosure. In the drawings:

FIG. 1 is a schematic illustration showing a first exemplary embodiment of the communication between one or more devices within a home and a secondary power source;

FIG. 2 is a schematic illustration similar to FIG. 1 illustrating further communication between the secondary power source and a series of individual devices along with a series of wireless power management modules;

FIG. 3 is a schematic illustration of a second exemplary embodiment of the present disclosure showing the communication between one or more devices within a home and a secondary power source; and

FIG. 4 is a schematic illustration similar to FIG. 3 illustrating further communication between the secondary power source and a series of individual devices along with a series of wireless power management modules.

### DETAILED DESCRIPTION

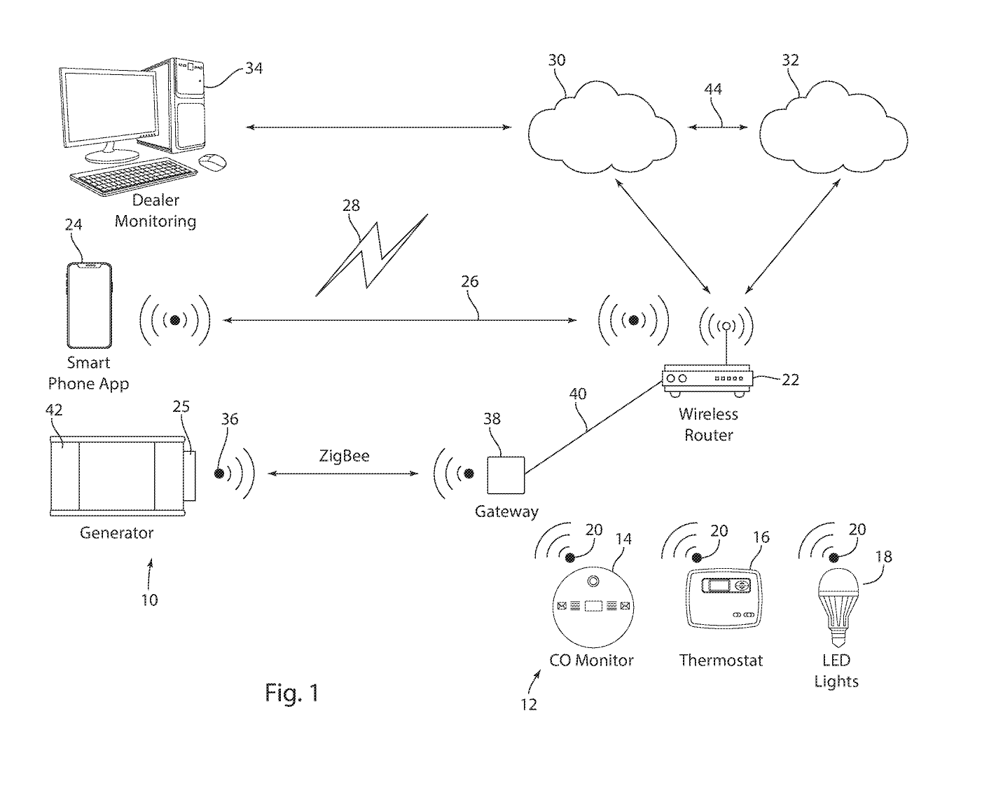

FIG. 1 illustrates one exemplary embodiment of the system and method of the present disclosure for providing communication between a secondary power source 10 and a variety of devices 12 within a home or small business. In the exemplary embodiment shown in FIG. 1, the devices 12 include a CO monitor 14, an enabled thermostat 16 and an enabled LED light 18. A wide variety of other devices could be included, such as refrigerators, ovens, appliances, smoke detectors, security systems, weather sensors, garage door openers, heating units, or other types of devices in a home or business. The number and type of devices commercially available is increasing yearly and the present disclosure contemplates communication with any type of device in a home. Each of the devices 12 shown in FIG. 1 include a wireless transceiver 20 that allows the devices 12 to both communicate information away from the device 12 and receive instructions and information.

In the embodiment shown in FIG. 1, a wireless router 22 is configured to receive information from the individual devices 12 as well as to communicate information to the wireless devices 12 utilizing a common wireless communication technique, such as but not limited to Wi-Fi. In the embodiment shown in FIG. 1, the wireless router 22 is also able to directly communicate with a personal wireless device 24, such as a smartphone, utilizing application software present on the wireless device 24. The wireless communication to the personal wireless device 24 is shown along line 26. When a user possessing the wireless device 24 is within the Wi-Fi range of the wireless router 22, the user will be able to monitor the wireless signals and information received from the various devices 12 through the local wireless connection created by the wireless router 22. In an embodiment in which the personal wireless device 24 is a smartphone, the personal wireless device 24 will be able to communicate not only over the Wi-Fi connection but also using a cellular signal 28. The cellular signal communication 28 will allow the wireless device 24 to communicate to the wireless router 22, and thus the devices 12, through a cloud service when the personal wireless device 24 is outside of the local wireless network. In this manner, the user of the wireless device 24 will be able to monitor the devices 12 from any location, as will be discussed below.

The wireless router 22 is shown communicating to two different cloud services, referred to as a first cloud service 30 and a second cloud service 32. A cloud service is any service that is available to users on demand via the Internet from a cloud computing provider's servers rather than the company's own on premise services. Although two separate cloud services are shown, one cloud service could be used while operating within the scope of the present disclosure. The two cloud services 30, 32 shown may serve two or more different functions or have different levels of detail, security and accessibility.

In the embodiment shown, the first cloud service 30 includes the required security such that the first cloud service can be accessed by a dealer 34, such as the manufacturer/distributer or dealer for any one of the wireless devices 12 and/or for the secondary power source 10. The secondary power source 10 includes a control unit 25 that is in operative communication with a wireless transceiver 36 such that the control unit 25 of the secondary power source 10 can communicate information from the secondary power source 10 as well as receive operating information/instructions utilizing wireless communication techniques. In the embodiment shown in FIG. 1, a gateway device 38 is connected to the wireless router 22 along a hardwired communication line 40. Although a hardwired communication line 40 is shown in FIG. 1, it should be understood that the gateway device 38 could also communicate with the wireless router 22 utilizing a wireless communication technique.

The embodiment shown in FIG. 1, the gateway device 38 includes an internal wireless transceiver such that the gateway device 38 can communicate with the control unit 25 of the secondary power source 10 utilizing a wireless communication technique other than Wi-Fi. In the embodiment shown in FIG. 1, Zigbee® is the preferred communication technique for the wireless transceiver of the gateway device 38 based on the security features and general availability of the communication band and components, although other types of wireless communication protocols are contemplated as being within the scope of the present disclosure.

In the embodiment shown in FIG. 1, in an exemplary embodiment, the secondary power source 10 is a standby generator 42. Although a standby generator 42 is shown, it should be understood that other types of secondary power sources, such as a battery hybrid system, a solar system or any other type of alternate power source that can be utilized upon disruption of utility power can be utilized while operating within the scope of the present disclosure.

As can be understood in FIG. 1, each of the wireless devices 12 communicates to the wireless router 22, which in turn communicates with the gateway device 38 over the communication line 40. The gateway device 38 is in wireless communication with the control unit 25 of the secondary power source 10 such that information transmitted from any one of the devices 12 can be received and acted upon by the control unit 25 of the secondary power source 10. In another contemplated embodiment, the wireless devices 12 could include Zigbee wireless transceivers and thus communicate directly to the gateway 38 or to some other dedicated Zigbee gateway.

As an illustrated example, if the secondary power source 10 is a gas-powered standby generator 42, the control unit 25 of the generator 42 can continuously monitor signals from the CO monitor 14. If the CO monitor 14 trips and generates and alarm upon sensing CO levels above a threshold value, the unsafe level of CO within the home will be sent and received at the control unit 25. Upon receiving such alarm condition, the control unit 25 of standby generator 42 can act to turn off the engine of the generator. A high level of the CO detected by the CO monitor 14 may indicate improper operation of the standby generator 42 or improper venting of exhaust gases from the internal combustion engine running within the generator 42. The communication between the CO monitor 14 and the control unit 25 allows the control unit 25 to modify the operation of the secondary power source 10 based on signals from the CO monitor 14. Similar actions are also possible based on signals received from any of the wireless devices 12.

As discussed previously, information from the wireless devices 12 and the secondary power source 10 can be communicated to both the proprietary network 30 or a public network 32. The public network 32 would allow an individual home or business owner to monitor the operation of both the secondary power source 10 and the series of wireless devices 12. The proprietary network 32 will primarily allow restricted access for a dealer/manufacturer/distributer to monitor the operation of the wireless devices 12 and/or the secondary power source 10. The two networks 30, 32 could communicate with each other, as indicated by the arrow 44. In addition, the two networks 30,32 could be combined and access controlled using passwords and authentication techniques.

In addition to receiving information from the wireless devices 12, the control unit 25 of the secondary power source 10 could also provide communication commands to the wireless devices 12. As an illustrated example, if the secondary power source 10 is providing electrical power to maintain the operation of a home, the control unit 25 of the secondary power source 10 could issue a signal to either lower the temperature within the home during winter months or raise the temperature in the home during operation of an air conditioner during summer months in order to conserve power. Since the secondary power source 10 either has a limited maximum power output, such as in the case of a standby generator, or has a limited amount of stored power, such as in the case of a battery hybrid system, there is an incentive to reduce energy consumption by the home during periods of operation of the secondary power source. Similar signals could be sent to other electrical devices, such as the LED lights 18 or other non-essential energy consuming loads within the home. In this manner, the control unit 25 of the secondary power source 10 could control the amount of energy consumed within the home through the wireless devices 12.

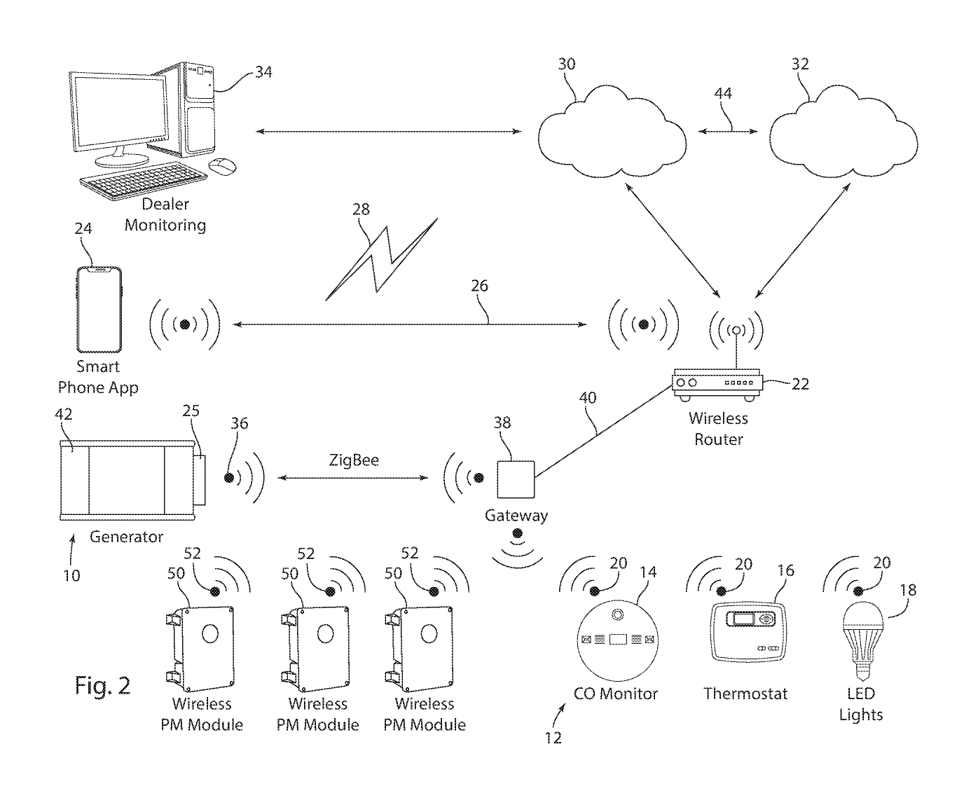

FIG. 2 is an enhanced exemplary embodiment of the system shown in FIG. 1. In the embodiment shown in FIG. 2, the system further includes a series of wireless power management (PM) modules 50. The power management modules 50 each include a wireless transceiver 52 that allows the module 50 to communicate with the gateway 38 using Zigbee or another similar wireless transmission technique. Alternatively. The power management module 50 could include a WiFi transceiver such that the power management module could communicate directly to the gateway 38. The power module could also be designed to include both a WiFi and Zigbee transceiver. The use of the power management modules 50 allows for a larger variety of energy consuming loads to be monitored and controlled. The power management modules 50 communicate information either to one of the wireless networks 30, 32 or directly to the secondary power source 10. In this manner, the control unit 25 of the secondary power source 10 may be able to control the operation of large energy consuming devices utilizing wireless communication from the control unit 25, through the gateway 38 and to any one of the series of wireless power management modules 50. The wireless power management modules 50 can be connected to high powered appliances, such as air conditioners, dryers, electric ovens, electric heaters, pool pumps or other high energy consuming loads. The secondary power source 10 can include control components that can reduce the amount of energy consumption at certain times of the day to conserve standby resources and to prevent overloading of a standby generator.

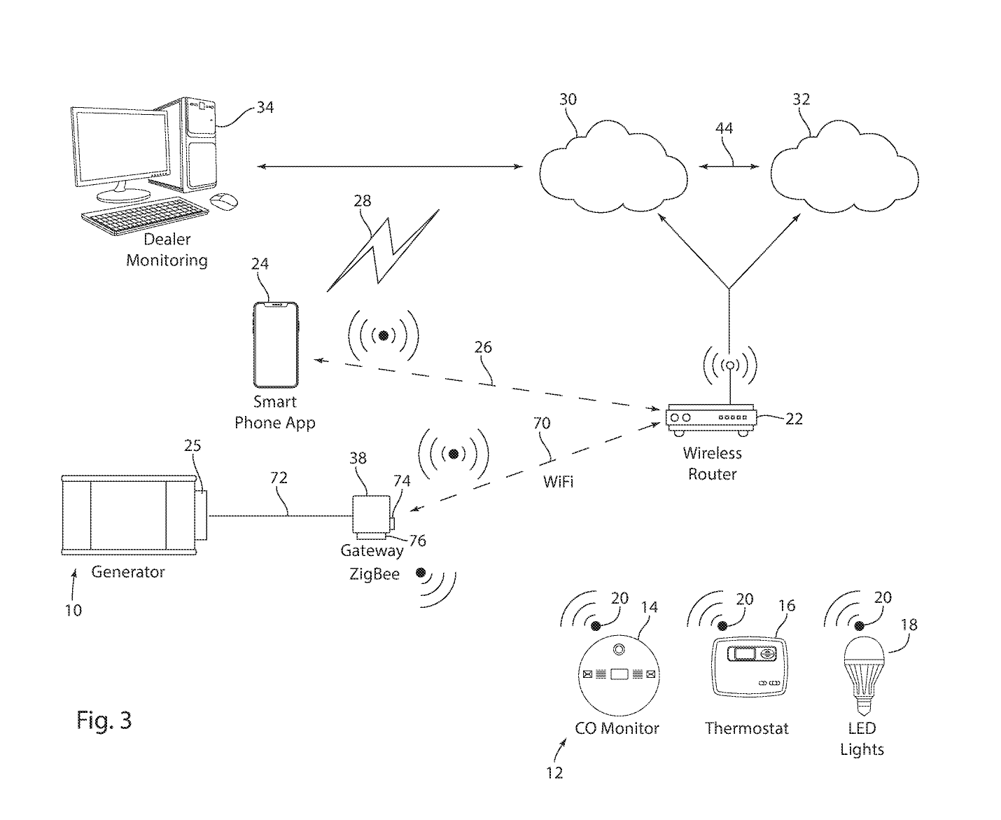

FIG. 3 illustrates another exemplary embodiment of the system and method of the present disclosure for providing communication between a secondary power source 10 and a variety of devices 12 located within a home or a small business. In the embodiment shown in FIG. 3, the wireless router 22 is again able to communicate information to and from the wireless devices 12 utilizing a common wireless communication technique, such as but not limited to Wi-Fi. In the embodiment shown in FIG. 3, the gateway 38 is designed to include both a Wi-Fi transceiver 74 and a Zigbee® transceiver 76. The Wi-Fi transceiver 74 allows the gateway 38 to communicate with the Wi-Fi router 22 utilizing a Wi-Fi communication path 70.

In the embodiment shown in FIG. 3, the gateway 38 is directly connected to the generator control unit 25 utilizing a hardwire connection 72, such as RS-485 serial cable. As discussed, the gateway 38 will include the Wi-Fi transceiver 74 and the Zigbee transceiver 76 such that the gateway 38 is able to communicate utilizing two different types of wireless communication techniques. Once again, although Zigbee is shown and described in the exemplary embodiment of FIG. 3, other wireless communication techniques are contemplated as being within the scope of the present disclosure and Zigbee set forth as one example technique. The Zigbee transceiver 76 is able to receive wireless communications from any of the wireless devices 12 that may include a Zigbee transceiver rather than or in addition to a Wi-Fi transceiver. In an embodiment in which one or more of the devices 12 includes a Zigbee transceiver, direct communication could occur from the control unit 25 of the secondary power source 10 and one of the devices 12 through the gateway 38.

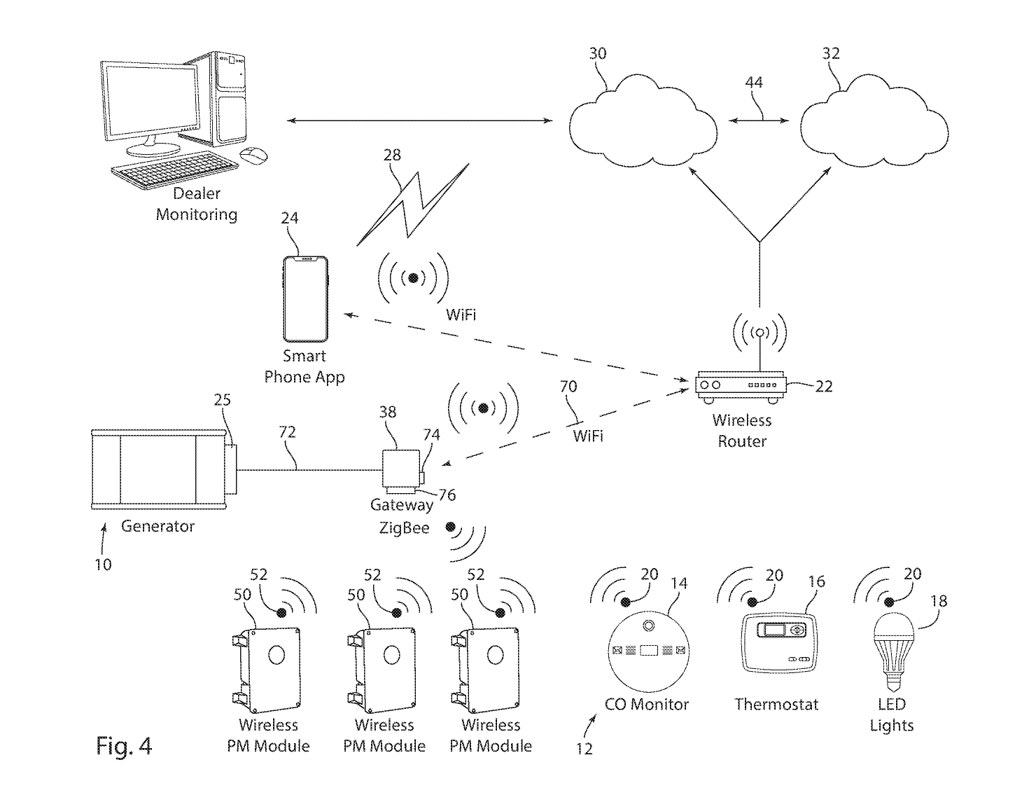

FIG. 4 is an enhanced embodiment of the system shown in FIG. 3. The system shown in FIG. 4 includes a series of wireless power management (PM) modules 50. The power management modules 50 each include a wireless transceiver 52 that allows the module 50 to communicate with gateway 38 utilizing a wireless communication technique, such as Zigbee. Since the gateway 38 includes a Zigbee transceiver 76, communication can take place directly between the gateway 38 and any one of the power management modules 50. The gateway 38, in turn, can communicate with the wireless router 22 over the Wi-Fi communication path 70 since the gateway 38 includes the Wi-Fi transceiver 74. It is contemplated that the power management modules 50, gateway 38 and the generator may be produced by the same manufacturer, which would enable the direct communication between the wireless power management modules 50 and the gateway 38. In the embodiment illustrated, the gateway 38 is designed with processing capabilities such that the gateway 38 is able to retrieve operating information from the control unit 25 of the secondary power source 10 and control the operation of the power management modules 50. The gateway 38 will be able to selectively turn off any of the power management modules 50 to shed loads when needed. In an alternate embodiment, the control unit 25 could include the processing capabilities and communicate to the power management modules 50 through the gateway 38.

As can be understood in the embodiments shown in the present disclosure, the communication system of the present disclosure allows the secondary power source 10, the devices 12 and the power management modules 50 to communicate with each other utilizing the gateway 38 and the Wi-Fi router 22. In this manner, the gateway 38 and/or the control unit 25 of the secondary power source 10 can receive information and control the operation of the devices 12 and any device connected to one of the wireless power management modules 50.

It is also contemplated that the control unit 25 contained within the secondary power source 10 can include different “scenes” that limit the amount of power draw on the secondary power source 10, based upon monitored parameters such as the current temperature, time of day, season of the year or any other information that may be relevant to limit the amount of power draw from high energy consuming loads. Further, the control unit 25 within the secondary power source 10 can include various different operating scenarios that send wireless control signals to the series of wireless power management modules 50 and the wireless devices 12. The two-way communication between the secondary power source 10 and the various devices/modules allows the control unit of the secondary power source to control the operation of devices within a home/business during a power outage when power is being supplied by the secondary power source 10. This communication can be to proprietary modules connected to power consuming loads or to non-proprietary wireless devices 12.

In some embodiments, the control system within the secondary power source 10 may communicate with the user via application software (app) on a mobile device 24, e.g. smartphone. The app may receive data from, and transmit data to, the control system via the one or more cloud-based servers. The app may be configured to provide the user with various information about the secondary power source, such as battery voltage, on/off status, engine speed, power generation levels, existing faults, run time, voltage levels, power consumption, fuel levels, etc.

In some embodiments, the app may allow the user to transmit data to the secondary power source 10. For example, the user may provide instructions to the secondary power source 10, via the app, such as engine run or stop, fault clearing, etc. In some embodiments, the app may allow the user to communicate to the one or more power management module 50, thereby allowing the app to display a current load profile of the connected devices. In some embodiments, the user may be able to selectively connect or disconnect one or more loads from the secondary power source. In some embodiments, the power management module 50 can include circuitry that can allow the power management module 50 to connect and/or disconnect a connected load to the secondary power source. In some embodiments, the app may be configured to display the available power from the secondary power source along with the current energy consumption by the one or more loads. The app may further be configured to provide guidance to the user to allow the user to optimize the secondary power source by optimizing the loads. In some embodiments, the user may indicate that they want a specific load to be energized. The app may then indicate which loads could be shut off to allow for sufficient power to be available to power the desired load based on the available power and currently energized loads. In further embodiments, the user may be able to select multiple loads and/or certain loads at certain times, and the app can provide an indication of which loads would be required to be switched off to allow for the secondary power source to power the desired loads. Where the loads are connected to applicable power management modules, the app may be configured to instruct the power management module 50 to connect and disconnect loads to achieve the user's desired loading. In some embodiments, the app may perform the analysis of the loading (client-side). In other embodiments, the analysis is performed on a server, such as the cloud services described above.

In some embodiments the app may be configured to provide a notification to a user of certain events. For example, the app may inform the user that maintenance is required. In some embodiments, the app may track one or more maintenance persons via GPS. The app may further be configured to use location services, such as geo-fencing, to inform the user when a service technician arrives and/or departs from the user's property.

In some embodiments, the app and/or controller may monitor a fuel level of the fuel source for the secondary power source. In other embodiments, the controller and/or app may be configured to monitor and analyze one or more parameters associated with the secondary power source, such as temperature, fuel consumption, oil pressure, oil temperature, vibration, power output, etc. In some embodiments, the controller, app and/or cloud service can analyze the parameters to perform predictive fault analysis. Based on the analysis, the user may be notified of an expected fault or failure via the app. In some embodiments, the expected fault or failure may be automatically provided to a service provider or technician so that maintenance can be scheduled. Further, the controller and/or cloud services can allow for remote diagnostics of the secondary power source, such as by the service provider.

In some embodiments, the controller, cloud services, and/or app may be configured to communicate with other services. In some examples, the controller, cloud services, and/or app may communicate with other services via an application programming interface (API). Other services can include, fuel ordering services, maintenance services, weather services, etc. In some examples, the app may provide an indication of impending inclement weather via a weather service.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An energy management and communication system, comprising:
a secondary power source including a wireless communication device;
a plurality of electronic devices each including a wireless transceiver;
a gateway in communication with both the plurality of wireless devices and the secondary power source,
wherein the secondary power source communicates with the wireless electronic devices through the gateway.

2. The system of claim 1 wherein the secondary power source is a standby generator.

3. The system of claim 2 wherein the electronic devices include a CO monitor.

4. The system of claim 1 further comprising a plurality of wireless power management modules each connected to an energy consuming device within a home, wherein each of the power management modules includes a wireless transceiver such that the secondary power source communicates with the plurality of power management modules.

5. The system of claim 1 further comprising a personal wireless device including an application software program, wherein the personal wireless device is in communication with the secondary power source.

6. The system of claim 1 further comprising a wireless router in communication with the gateway and the plurality of electronic devices.

7. The system of claim 6 wherein the wireless router communicates with the plurality of electronic devices using a first communication protocol and the gateway communicates with the secondary power source using a second communication protocol different from the first communication protocol.

8. The system of claim 1 wherein the secondary power source includes a control unit operable to control operation of the secondary power source and to generate control commands to at least one of the electronic devices and receive information from at least one of the electronic devices.

9. The system of claim 4 wherein the secondary power source includes a control unit operable to control operation of the secondary power source and to generate control commands to at least one of the power management modules.

10. The system of claim 4 wherein the gateway is operable to obtain operational information from the secondary power source and to generate control commands to at least one of the power management modules.

11. An energy management and communication system, comprising:
a secondary power source including a control unit and a wireless communication device;
a plurality of electronic devices each including a wireless transceiver;
a personal wireless device including an application software program;
a local wireless communication device in communication with the plurality of wireless devices, the personal wireless device and the control unit of the secondary power source,
wherein the secondary power source communicates with the wireless electronic devices and the personal wireless device through the local wireless communication device.

12. The system of claim 11 further comprising a plurality of wireless power management modules each connected to an energy consuming device, wherein each of the power management modules includes a wireless transceiver such that the secondary power source communicates with the plurality of power management modules.

13. The system of claim 11 wherein the local wireless communication device includes a wireless router in communication with the personal wireless device and the plurality of electronic devices.

14. The system of claim 13 wherein the local wireless communication device includes a gateway in communication with both the wireless router and the control unit of the secondary power source.

15. The system of claim 14 wherein the wireless router communicates with the plurality of electronic devices and the personal wireless device using a first communication protocol and the gateway communicates with the secondary power source using a second communication protocol different from the first communication protocol.

16. The system of claim 14 wherein the gateway includes a first wireless transceiver and a second wireless transceiver, wherein the gateway communicates with the wireless router through the first wireless transceiver and the gateway communicates with a plurality of wireless power management modules through the second wireless transceiver.

17. The system of claim 14 wherein the control unit is operable to control operation of the secondary power source and to generate control commands to at least one of the electronic devices.

18. The system of claim 16 wherein the control unit and gateway are operable to control operation of the secondary power source and to generate control commands to at least one of the power management modules.

19. The system of claim 11 wherein the application software program on the personal wireless device communicates with the plurality of electronic devices and the secondary power source.

20. The system of claim 19 wherein the personal wireless device receives information from control unit related to operation of the secondary power source and issues commands to the control unit to control operation of the secondary power source.

21. The system of claim 19 wherein the personal wireless device receives information from the plurality of electronic devices and issues commands to the plurality of electronic devices to control operation of the plurality of electronic devices.
